(19) United States
(12) Patent Application Publication
(10) Pub. No.: US 2007/0253336 A1
(43) Pub. Date: Nov. 1, 2007

(54) Method and system for providing passive status messaging

(76) Inventor: Jose Martinez, Perth Amboy, NJ (US)

Correspondence Address: DUANE MORRIS LLP, Suite 700, 1667 K Street, N.W., Washington, DC, 20006, US

(21) Appl. No.: 11/711,018

(22) Filed: Feb. 27, 2007

Related U.S. Application Data
(60) Provisional application No. 60/776,735, filed on Feb. 27, 2006.

(51) Int. Cl. H04L 12/26

(52) U.S. Cl. 370/242; 370/271

(57) ABSTRACT

Disclosed embodiments are generally directed to systems and methods for providing passive status messaging for a network communications device at a remote node of a network. A disclosed method includes detecting a status condition at the remote node, selecting a message from a plurality of messages stored in the network communications device, where the message corresponds to the detected status condition, and communicating the message.

The disclosure claims the filing-date benefit of Provisional Application No. 60/776,735, filed Feb. 27, 2006, and incorporated herein in its entirety.

### FIELD OF THE INVENTION

The present disclosure relates generally to systems and methods for providing passive status messaging at a remote node of a network.

### BACKGROUND

As Voice over Internet Protocol (VoIP) services become more popular and widely-accepted, VoIP service providers must continue to meet and exceed the functionality and features of existing Public Switched Telephone Network (PSTN) communication systems as experienced by the end user or customer. Conventionally, a VoIP terminal adapter device at a remote node of a VoIP communications network, such as a customer's premises, is configured to play a dial-tone only when certain criteria are met. These criteria include that the device has network connectivity and is registering with Session Initiation Protocol (SIP) proxy servers. If the device is not working properly with the VoIP system, no further indications other than the lack of dial-tone are available to the customer. Moreover, a lack of dial-tone is caused by any number of failed criteria and combinations thereof. Thus, when a customer does not hear a dial-tone, the customer is at a loss on how to effectively troubleshoot the problem. This frustration leads to an increase in the number of phone calls and emails to VoIP provider customer care representatives. Further, since the lack of a dial-tone can be indicative of any number of problems, the customer care representative faces the daunting task of walking the often irritated customer through a list of troubleshooting steps designed to diagnose and solve a problem with the device or connection.

Accordingly, there is a need in industry for technological solutions providing a more efficient system and method for enabling customers to address network setup issues themselves and to improve the ability of customer care representatives to troubleshoot these issues more effectively and efficiently.

### SUMMARY

Various disclosed embodiments are generally directed to systems and methods for providing passive status messaging for a network communications device at a remote node of a network. A disclosed method includes detecting a status condition at the remote node, selecting a message from a plurality of messages stored in the network communications device, where the message corresponds to the detected status condition, and communicating the message.

### BRIEF DESCRIPTION OF THE DRAWINGS

Various aspects of the present disclosure will be or become apparent to one with skill in the art by reference to the following detailed description when considered in connection with the accompanying exemplary non-limiting embodiments, wherein:

FIG. 1 illustrates a schematic diagram of network architecture including a remote node;

FIG. 2 is a flow chart outlining an exemplary disclosed method;

FIG. 3 is a flow chart outlining device preparation steps to enable a voice call over a packet-based network; and

FIG. 4 is a schematic illustration of an exemplary network communications device.

### DETAILED DESCRIPTION

One aspect of the present disclosure includes providing passive status messaging including communicating a message corresponding to a detected device status condition. Another aspect includes updating stored status messages. Yet another aspect includes providing an instruction with the message to guide a user in troubleshooting the device. An additional aspect includes providing further messages as the status is updated to guide a user through more lengthy troubleshooting processes. In yet another aspect, a log of communicated status messages is stored and transmitted over the network. In a further aspect, the status messages are communicated through an audio speaker, a text display such as a caller-ID display, or an administrative website provided by the device.

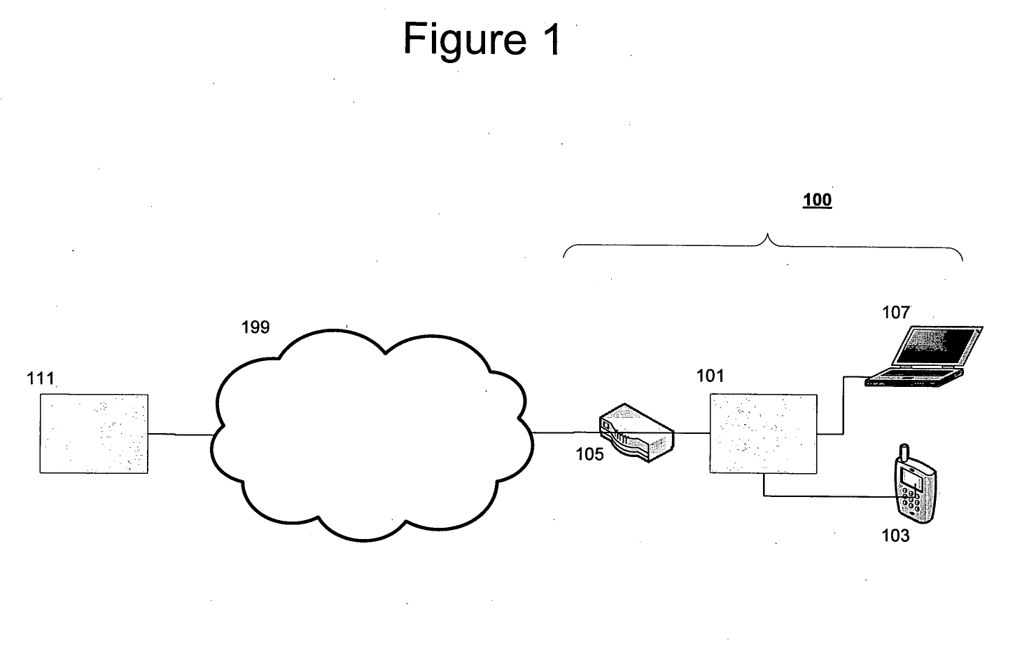

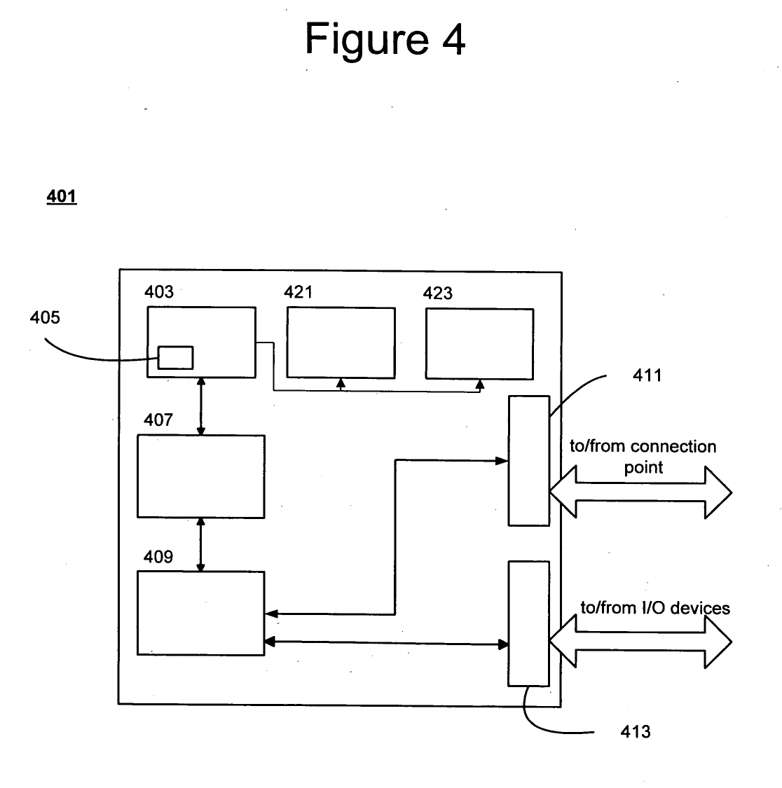

FIG. 1 illustrates a schematic diagram of network architecture including a remote node 100. At the remote node 100, a terminal adapter device 101 is operably connected to a telephone 103, router 105, and a computer 107. Through the router 105, the terminal adapter device 101 facilitates VoIP calls over the Internet 199 by establishing a connection with service provider network entities such as a SIP proxy server 111. An exemplary embodiment of the device 101 is illustrated in FIG. 4, discussed in greater detail elsewhere.

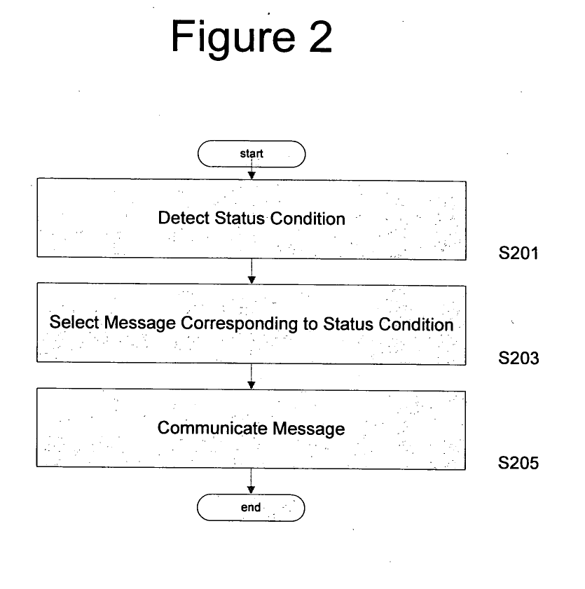

FIG. 2 illustrates a flow-chart outlining an exemplary disclosed method. The method includes detecting a first status condition at the remote node S201. The first status condition includes a device workflow step and a device workflow criteria. The method also includes selecting a first message from a plurality of messages stored in the network communications device S203. The first message corresponds to the detected status condition. The first message is then communicated S205.

If the device 101 is functioning properly within the VoIP network and able to complete VoIP calls, the device 101 provides a dial-tone to the customer through, for example, the speaker of a telephone 103 handset connected to the device 101. However, if the device 101 is not functioning properly, the device 101 detects a status condition including the particular process step at which an error occurred and an error criteria, such as a device error or network error. This detection step occurs automatically without requiring the customer to poll the device or otherwise actively request information regarding the error. A device error or fault includes, but is not limited to, a configuration profile error, a firmware error, a power failure, and a hardware malfunction. A network error includes, but is not limited to, a lack of network connectivity, improper network settings, firewall or anti-virus program interference with a network connection, and insufficient bandwidth. Further examples of process steps and criteria are described elsewhere.

In an operational example, a fault has occurred in the course of normal VoIP device registration and setup. When a dial-tone is not given, the customer automatically receives a passive status message (i.e., the message is delivered to the customer without having to actively engage the device or service) corresponding to the particular stage of registration and setup where the fault occurred. Accordingly, the customer is enabled to perform initial troubleshooting. If the customer's efforts are unsuccessful, the customer can call customer care representatives and provide them with the details of the passive status message. The customer care representatives are then able to more easily troubleshoot the customer's problem with knowledge of the status of the device 101 communicated through the status message. In certain embodiments, the passive status message or instruction includes a message identifier to enable quicker and more accurate description of the passive status message by the customer to the care representative.

In various embodiments, the passive status messages are communicated in various ways including, but not limited to, prerecorded voice messages, text display messages delivered directly to the customer via a connected phone, and automatic delivery to the customer through an administrative webpage served by the device 101, the customer's VoIP service webpage, email or cell phone.

Along with the status message, various embodiments of the device 101 provide instructions to the user for correcting the problem. Various approaches to communicating the status messages and instructions for fixing detected status conditions such as faults and errors are described in greater detail elsewhere.

In various embodiments, the different context-based status messages are stored directly on the device 101 in, for example, a memory. In one embodiment, the status messages are embedded in the firmware of the device 101. In another embodiment, upon initial bootup of the device 101 and connection to the Internet 199, the status messages are downloaded from an external server according to its initial firmware. Passive status messages may additionally be downloaded to the VoIP device over the Internet 199. Optionally, status messages can be updated. Additional status messages could be downloaded at various times to update those already on the device. For example, device messages in a new language could be downloaded. Further, new messages that correspond to updates in the VOIP system could be downloaded. Alternatively, a subset of status messages and instructions are optionally embedded in firmware, and others are downloaded. In this embodiment, the embedded messages and instructions pertain to status conditions related to or often encountered during initial setup. The later-downloaded messages and instructions are stored in memory and pertain to status conditions related to or often encountered after successful initial setup of the device.

Embodiments optionally include providing further messages as the status is updated to guide a user through more lengthy troubleshooting processes. To facilitate the customer's ability to troubleshoot various issues, the device 101 optionally detects changes and updates to the device status conditions and provides corresponding messages and instructions. For example and as explained in greater detail below, after the customer successfully follows the instruction provided by the device 101 regarding a first problem related to the network settings, the device 101 may subsequently detect a problem resolving a hostname or registering with a SIP proxy server despite the customer's successful remedy of the network settings problem. In selected embodiments, the device 101 provides an additional status message and instruction regarding the new issues with the device 101.

In various embodiments, the device 101 maintains a history of detected device status conditions and messages or instructions to provide more targeted guidance to a customer. For example and as explained in greater detail below, a detected problem with obtaining network settings combined with a detected problem resolving a hostname may indicate a problem with the device's 101 operating system, configuration profile, or firmware. Accordingly, embodiments of the device 101 which take into account this status condition history may instruct a user to download a new configuration profile or firmware. Accordingly, the device 101 enables more advanced troubleshooting methods by analyzing a history of detected status conditions and communicated status messages and instructions.

In yet another aspect, a log of communicated status messages is transmitted over the network. In these embodiments, an error and attempted fix history is provided to a network service provider. The logs optionally include a list of communicated status messages or associated identifier codes, instructions, detected status conditions, timestamps, network and device settings, and hardware or software version numbers. The network service provider can use these logs to evaluate problems at multiple remote nodes 100. Analysis of this data is optionally used to provide updated status messages and instructions to devices 101. This data also illuminates potential problems with devices 101 interacting on the network and can be used to trigger and develop fixes to device 101 firmware or configuration profiles.

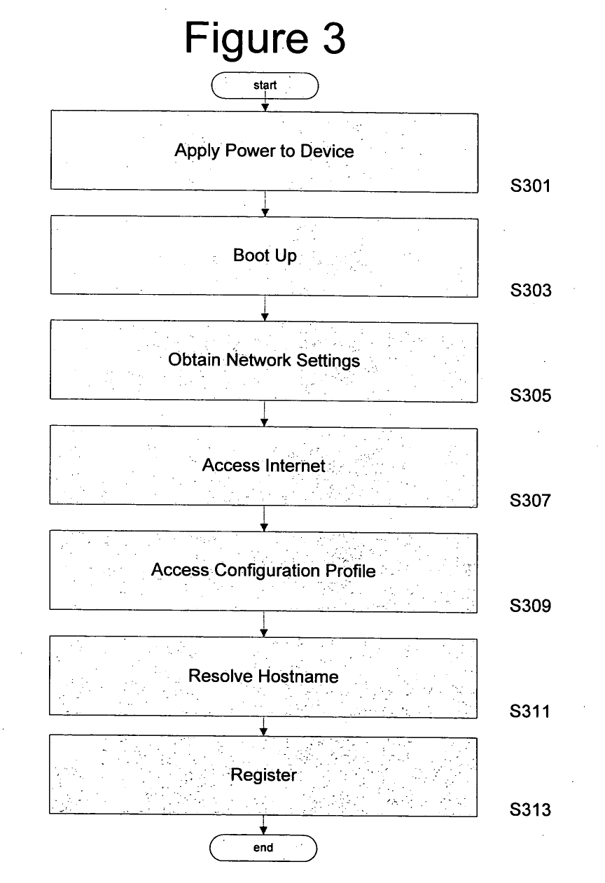

In terms of content and timing of communication, the status messages correspond to the process steps and criteria involved for the device 101 to make a VOIP phone call. FIG. 3 is a flow chart outlining preparation steps to enable a voice call over a packet-based network using a device 101.

In this exemplary process, power is applied to a VoIP device S301. The device then boots up S303. For example, the device needs to boot up various components including, but not limited to, its operating system, networking, and VOIP software. The device then obtains network settings S305. For example, the device obtains network settings either automatically (for example, through a protocol like DHCP) or a statically assigned network setting (for example, a static IP address). Once network settings are obtained, the device is able to access the Internet S307.

The device then accesses a configuration profile S309. In one embodiment, the device downloads a configuration profile (in other words, is provisioned) from a remote source over the Internet. Alternatively, if the configuration profile is already present on the device, the profile is located and loaded. The configuration profile informs the device regarding a variety of operational functions including, but not limited to, which servers to contact during initialization, updates, and communications, usernames and passwords required to connect to the network, and other vital information needed for making VOIP calls. Once the device is provisioned, it resolves the hostname of a VoIP server including, but not limited to, a SIP proxy server S311. Once the hostname has been resolved, the device registers with the VoIP server S313.

The Status Messages will be based on these process steps and various associated criteria. Table 1 illustrates exemplary messages based on exemplary steps and criteria.

TABLE 1

| Criteria | Step | Message |
|---|---|---|
| Device is not | Loading or | “Device is not provisioned.” |
| provisioned | applying profile | |
| Line is not | Loading or | “Line is not provisioned for |
| provisioned | applying profile | use. Please try the other line.” |
| Device is | Device is | “Line is not yet available, |
| provisioned | booting-up | please wait.” |
| Device has | Connecting | “Device has no network |
| no network | to network | connectivity. Please check |
| connectivity | | your broadband connection.” |
| Device has | Connecting | “Device has no network |
| no network | to network | settings.” |
| settings | | |
| Device | Connecting to | “Device cannot resolve |
| cannot DNS | VoIP network | servers.” |
| resolve | | |
| Proxy hostname | | |
| Device | Connecting to | “Device is unable to connect |
| gets no | VoIP network | to servers.” |
| response | | |
| from servers | | |
| Device | Connecting to | “Device has used an |
| cannot register | VoIP network | incorrect password while |
| because of | | trying to authenticate.” |
| incorrect | | |
| password | | |
| Device gets | Connecting to | “Device received an error |
| error from | VoIP network | while trying to register.” |
| servers | | |

Additions and variations of Status Messages correspond to new criteria and steps added for the device to make VOIP phone calls. Further granularity of device or network process steps and criteria is also supported in various embodiments.

For instance, the device may have no network connectivity for a variety of reasons. These reasons include, but are not limited to: 1) The WAN interface is not connected; and 2) The device has an IP address but Address Resolution Protocol (ARP) requests to its default gateway (GW) are not being responded to or otherwise acknowledged. If the device encounters a situation where its SIP packets are not being responded to, various embodiments of the device 101 begin sending ARP requests to its default GW to verify that it still has connectivity to it. In another example, the device may have no network settings because the device is unable to get network setting information from Dynamic Host Configuration Protocol (DHCP) server or the device does not have network static information assigned. Appropriate status messages and instructions are provided to enable a customer to confirm such faults and troubleshoot them.

Various embodiments include multiple modalities for communicating the status messages to a customer or user at a remote node. The selection of the various modalities is based on a variety of criteria including, the nature of the message, the capabilities of the device, or the customer's situation. In one embodiment, the status message is played through a phone 103 operably connected to or integrated with the device 101. In certain embodiments, the device 101 plays the status message through the phone 103 and further directs the customer on actions to resolve the detected problem with the device 101. When the user picks up the phone handset, the device either plays the dial-tone if it is ready and able to make a VoIP call or it automatically plays the status message and instructions to guide the customer towards resolving the issue.

In another embodiment, the status message is displayed on a display (for example; a multi-function or text caller-ID screen) on the phone 103 operably connected to or integrated with the VOIP device 101. In this embodiment, the status message and instructions are displayed on the caller-ID screen (or other display device) that are included in certain phones 103. In this embodiment, the device 101 uses methods such as Dial-Tone Multi-Frequency (DTMF) signaling to communicate data for display on a caller-ID screen or it makes use of a direct interface to the display, for instance, if the device 101 and the phone 103 are integrated. When the customer picks up the phone handset, the status message is displayed to the caller-ID screen on the phone 103 or displayed on the device 101 directly (for instance, if the device 101 includes a display).

In yet another embodiment, the status message is displayed on an administrative website of the device 101 accessible to a user or customer at a remote node. In this embodiment, the device 101 is configured to serve pages of an administrative website reflecting administrative settings and controls to a computer 107 connected thereto. At the administrative website (for example, located on the remote node portion of the network using a reserved DHCP IP address such as 192.168.0.1), the user can log-in to install or configure the device 101. In certain embodiments, the administrative website includes a section where the status message and any corresponding instructions are displayed to the user. Preferably, this website is accessible regardless whether the device 101 is able to connect through the Internet 199 to remote network entities such as the SIP proxy server 111. Optionally, the status message or instruction includes a graphic or diagram.

FIG. 4 is a schematic illustration of an exemplary network communications device 401. The device 401 may be used to facilitate the system and methods for providing passive status messaging described above. The device 401 may be one of any form of a general purpose computer processor used in accessing an IP-based network such as a corporate intranet, the Internet or the like. The device 401 comprises a central processing unit (CPU) 407, a memory 403, and support circuits 409 for the CPU 407.

The device 401 optionally includes or communicates with a display 421 for communicating visual information to a customer. The device 401 optionally includes or communicates with a speaker 423 for communicating audio information to a customer. The device 401 is optionally integrated with a phone 103 or a router 105. Alternatively, the device 401 is implemented using software running on a computer 107, thereby operating as a softphone similar to various embodiments described in U.S. application Ser. No. ______ filed Feb. 13, 2007, entitled “METHOD AND SYSTEM FOR MULTI-MODAL COMMUNICATIONS,” and incorporated herein in its entirety. In another alternative, the device 401 is a separate but complementary device with a form factor such as a V-PHONE™ Universal Serial Bus (USB) key manufactured and sold by Vonage of Holmdel, N.J. for use with a computer 107 to enable the computer 107 to make VoIP calls.

The device 401 also includes provisions 411/413 for connecting the device 401 to the customer equipment and service provider agent equipment and the one or more input/output devices (not shown) for accessing the device 401 and/or performing ancillary or administrative functions related thereto. Note that the provisions 411/413 are shown as separate bus structures in FIG. 4; however, they may alternately be a single bus structure without degrading or otherwise changing the intended operability of the device 401 or invention in general. In embodiments where the device 401 is integrated with another device such as a phone 103, a router 105, or a computer 107, the device 401 optionally communicates with a display, speaker, or other input/output features of the other device through, for example, provisions 411/413.

Additionally, the device 401 and its operating components and programming as described in detail below are shown as a single entity; however, the device may also be one or more devices and programming modules interspersed around the system each carrying out a specific or dedicated portion of the diagnostic analysis as described earlier. By way of non-limiting example, a portion of the device 401 or software operations may occur at a Service Provider server and another a portion of the device 401 or software operations may occur at the service provider agent equipment. Other configurations of the device and device programming are known and understood by those skilled in the art.

The memory 403 is coupled to the CPU 407. The memory 403, or computer-readable medium, may be one or more of readily available memory such as random access memory (RAM), read only memory (ROM), floppy disk, hard disk, flash memory or any other form of digital storage, local or remote. The support circuits 409 are coupled to the CPU 407 for supporting the processor in a conventional manner. These circuits include cache, power supplies, clock circuits, input/output circuitry and subsystems, and the like. A software routine 405, when executed by the CPU 407, causes the device 401 to perform processes of the present invention and is generally stored in the memory 403. The software routine 405 may also be stored and/or executed by a second CPU (not shown) that is remotely located from the hardware being controlled by the CPU 407.

The software routine 405 is executed when a preferred method of diagnosing VoIP related communication faults is desired. The software routine 405, when executed by the CPU 407, transforms the general purpose computer into a specific purpose computer (device) 401 that controls the web-based application, suite of diagnostic tools or other similar actions. Although the process of the present invention is discussed as being implemented as a software routine, some of the method steps that are disclosed therein may be performed in hardware as well as by the software device. As such, the invention may be implemented in software as executed upon a computer system, in hardware as an application specific integrated circuit or other type of hardware implementation, or a combination of software and hardware. The software routine 405 of the present invention is capable of being executed on computer operating systems including but not limited to Microsoft Windows 98, Microsoft Windows 2000/XP/Vista, Apple OS X and Linux. Similarly, the software routine 405 of the present invention is capable of being performed using CPU architectures including but not limited to IBM Power PC, Intel x86, Sun service provider agentRC, AMD, Transmeta, and Intel ARM.

It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

What is claimed is:

1. A method for providing passive status messaging for a network communications device at a remote node of a network, comprising:
detecting a first status condition at the remote node, the first status condition including a device workflow step and a device workflow criteria;
selecting a first message from a plurality of messages stored in the network communications device, the first message corresponding to the detected status condition; and
communicating the first message.

2. The method of claim 1, further comprising:
receiving at least one updated message at the remote node; and
storing the at least one updated message.

3. The method of claim 1, further comprising:
selecting an end-user instruction from a plurality of instructions, the instruction corresponding to the detected status condition; and
communicating the end-user instruction.

4. The method of claim 1, further comprising:
detecting a second status condition at the remote node;
selecting a second message from the plurality of messages, the selected second message corresponding to the second status condition; and
communicating the second message.

5. The method of claim 1, further comprising:
storing the first status condition and the first message;
detecting a second status condition at the remote node;
selecting a second message from the plurality of messages, the second message corresponding to the first status condition, the first message, and the second status condition; and
communicating the second message.

6. The method of claim 1, wherein the step of communicating includes playing a prerecorded audio message.

7. The method of claim 1, wherein the step of communicating includes displaying a text message.

8. The method of claim 1, wherein the step of communicating includes displaying the message on a webpage served by the network communications device at the remote node.

9. The method of claim 1, wherein the step of communicating includes transmitting a message identification code corresponding to the first message.

10. The method of claim 1, further comprising:
recording communication of the first message in a device log; and
transmitting the device log over the network.

11. A computer program product for use with a device on a communications network, comprising:
a computer usable medium having computer readable program code modules embodied in the medium for providing passive status messaging for a network communications device at a remote node of a network;
a computer readable first program code module for causing a computer to detect a first status condition at the remote node, the first status condition including a device workflow step and a device workflow criteria;
a computer readable second program code module for causing a computer to select a first message from a plurality of messages stored in the network communications device, the first message corresponding to the detected status condition; and
a computer readable third program code module for causing a computer to communicating the first message.

12. A system for providing passive status messaging for a network communications device at a remote node of a network, comprising:
a status detector configured to detect a status condition at the remote node;
a memory, the memory including a plurality of messages stored therein;
a processor coupled to the memory and configured to select a first message from the plurality of messages, the first message corresponding to the status condition; and
means for communicating the first message.

13. The system of claim 13, wherein the means for communicating includes an audio speaker.

14. The system of claim 13, wherein the means for communicating includes a text display.

15. The system of claim 13, wherein the means for communicating includes a web server configured to output webpage data accessible at the remote node.
